(19) United States
(12) Patent Application Publication
(10) Pub. No.: US 2009/0047614 A1
(43) Pub. Date: Feb. 19, 2009

(54) Dental Retainer

(75) Inventors: Mervyn Fathianathan, Savannah, GA (US); Renuga Gopal, Singapore (SG); A.P.A. Bindu Saran, Singapore (SG); Rachel Shanti Choudhury, Singapore (SG); Teo Chieh Yin Karen, Singapore (SG); George Aliphtrias, Singapore (SG)

Correspondence Address: WELLS ST. JOHN P.S., 601 W. FIRST AVENUE, SUITE 1300, SPOKANE, WA, 99201, US

(73) Assignee: BIOMERS PRODUCTS LLC, Naples, FL (US)

(21) Appl. No.: 11/839,393

(22) Filed: Aug. 15, 2007

(51) Int. Cl. A61C 7/08

(52) U.S. Cl. 433/6

(57) ABSTRACT

The invention provides a dental retainer 100, suitable for use in retaining a user's teeth (not shown) in position, said dental retainer 100 comprising a curved labial bow member 110 suitable for abutment against the labial side of a row of teeth of a user, said bow member 110 being composed of a fiber reinforced matrix of a suitable thermoplastic material. The bow member 110 is configured and dimensioned to extend operationally from a first end 112a to a second end 112b along the labial side of a user's teeth from at least a pre-molar to a pre-molar on an opposed side of a user's mouth. The dental retainer 100 further comprises a pair of support members 120 which are connected to the ends 112a & b of the labial bow member 110 at their anterior ends 124a & b respectively. Preferably, the support members 120 are removably connected to the labial bow member 110 by means of a connector 130. The bow member 110 and the support member 120 are mounted to a user's teeth operationally by means of a mounting device, such as an Adam's clasp 142, cross over members 146 connected to a base plate 144, or a loop member 148 suitable for extending around a user's back molar to a base plate 144. The dental retainer 100 further includes a canine stabilization component 150 for stabilising the dental retainer against a user's canine teeth.

### FIELD OF THE INVENTION

The present invention relates to a dental retainer. More particularly but not exclusively it relates to a dental retainer utilising composite materials technology, and which is suitable for use within a user's mouth for encouraging towards and/or retaining pre-corrected teeth in their corrected position.

### BACKGROUND OF THE INVENTION

Dental retainers are widely known in dentistry. Dental retainers are devices which are worn within a user's mouth and which are used to retain teeth in their corrected state after they have been corrected by prior treatment. A typical retainer design is the “Hawley” design. This typically comprises a rigid metal wire made in the shape of a bow to stay in contact with the anterior or labial side of a line of corrected teeth, especially the incisors. Such a bow is called a labial bow. The labial bow provides anterior retention of the teeth. It discourages unwanted tooth movement and exerts forces on the teeth only in response to initiations of unwanted displacements of the tooth from the corrected state. The labial bow also comprises of transverse loops at its ends that permit the adjustment of force delivered by the bow. As the teeth settles into the final position, repeated adjustment of the labial bow, through the transverse loops are necessary

The labial bow is attached either directly or indirectly to a rigid base plate, which is disposed in use on the lingual side of the teeth, on the roof and/or floor of the oral cavity. The base plate is normally made up of transparent thermosetting plastic material such as methyl methacrylate. The labial bow is normally held in position by means of one or more of the following connection means:

(a) By means of “cross-over” pieces of metal wire which extend into the embrasures between the canine and the first premolar from the labial side to the lingual side of the tooth to the base plate;

(b) By means of brazing or soldering the labial bow to an “Adams clasp” (a clasp in the form of a loop which usually fits tightly over a molar, and is normally used for posterior retention); or

(c) By wrapping the labial bow around the distal side of the last molar and connecting it directly into the rear region of the base plate.

Materials commonly used for labial bows currently have several associated problems. The most commonly used material is stainless steel. Stainless steel wire is commonly used due to its favourable properties of high resistance to deformation and high resilience. However, such stainless steel wire exhibits high stiffness, resulting in the application of relatively heavy forces on teeth, which may have a detrimental effect on the teeth roots. Roots have been known to get shortened and weaker under the effect of heavy forces. Additionally, stiff stainless steel wire is also known to cause abrasion to tooth enamel.

A further problem associated with the use of stainless steel is that the poor aesthetic quality of stainless steel may have a negative effect on patient compliance. Lack of proper retention, due to patients not wearing these retainers as often as required may result in a corrected tooth moving out of position. When this occurs it may take a much longer time to correct the tooth again.

A number of alternative solutions have been proposed to improve the aesthetics of the traditional Hawley retainer. These include using thermoplastic filaments or flattened tabs to replace stainless steel labial bows. However, the use of thermoplastic labial bows has other inherent disadvantages. Thermoplastic material has to be heated to higher temperatures to soften them before carrying out any adjustment. In addition, thermoplastic material is not as resilient as stainless steel. The amount of adjustment that can be carried out is limited, as repeated adjustments of the thermoplastic may result in the labial bow snapping. Further, the only way of increasing the stiffness of thermoplastic material is by building up the material to larger thicknesses making the labial bow bulky and uncomfortable for the patient. Other publications which show alternative configurations of dental retainer devices include U.S. Pat. No. 6,332,774, U.S. Pat. No. 5,271,733, U.S. Pat. No. 5,376,001, U.S. Pat. No. 5,536,169, U.S. Pat. No. 5,607,300. However, none of these solve the multiple problems of having high aesthetic quality, flexibility, resistance to breakage and being easily able to be modified at various stages of treatment.

Another proposed solution has been the introduction of translucent or clear plastic trays which offer aesthetic alternatives. These are essentially trays made from the plaster mould of a mouth and which fit closely around the whole set of teeth. However, such trays can not be used under all conditions. In particular, such trays are not appropriate for people with widening arches, requiring high degrees of adjustment and for people having bad oral hygiene. Usage of the device has to be discontinued in the case where the gum has swollen and such trays can not be prescribed if the patient suffers from gingivitis. Retention of acids found in common foods such as fruit juices, carbonated drinks, etc. may cause demineralization of teeth due to acid leaching.

PCT patent application WO 2004/111112 A1 discloses the use of a fibre reinforced composite for use in an orthodontic device. Such fibre reinforced composites provide material properties which overcome some of the disadvantages of, in particular stainless steel and thermoplastic as described above. However, such fibre reinforced composite material also has its disadvantages in that it is not adjustable at all once it has been cured. Other orthodontic appliances have been proposed incorporating composite material technology. In particular, patent application numbers WO 03/092987 A2, EP 0230394 B1, U.S. Pat. No. 5,759,029, U.S. Pat. No. 5,869,178, U.S. Pat. No. 4,894,012, all disclose such devices. In particular, the use of such fibre reinforced composites allows good aesthetic qualities and high resilience, without the associated stiffness. A problem associated with the use of such fibre reinforced composites is that they are permanently set or cured, and that they do not allow the dental retainer to be modified or supplemented at various stages of treatment.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of the present invention to provide which overcomes or at least partly ameliorates some of the abovementioned disadvantages or which at least provides the public with a useful choice.

### SUMMARY OF THE INVENTION

In a first aspect the present invention broadly consists in a dental retainer, suitable for use in retaining a user's teeth in position, said dental retainer comprising

a curved labial bow member suitable for installation around the labial side of a row of teeth of a user, said bow member comprising
reinforcing fibers and
a polymer matrix; and

at least one elongate support member, suitable for operational disposition alongside a user's teeth in an anterior-posterior configuration, said support member being connected towards its anterior end to an end of the bow member.

Preferably the reinforcing fibers are ceramic fibers such as glass fibers or polymeric fibers such as polyethylene, polypropylene, Ultra High Molecular Weight Polyethylene (UHMWPE), Nylon, or the like.

Preferably the polymer matrix is of a high quality aesthetic nature as appropriate for orthodontic applications.

Preferably, the dental retainer comprises a pair of support members, each connected towards their anterior ends to opposed ends of the bow member.

Preferably, the support member(s) are connected in a removable manner to the bow member.

Preferably, the bow member is configured to extend operationally from at least the labial side of a pre-molar to the labial side of a pre-molar on an opposed side of a user's mouth. Preferably, the support member is connectable in a removable manner to the labial bow member by means of a connector.

Preferably, the support member is filamentary in nature.

Preferably, the support member is round in cross-section.

Preferably, the support member is composed of a stiff and resilient metal such as stainless steel, titanium or titanium alloys or any other material commonly employed in orthodontics

Preferably, the support member is formable, to enable the support member to be adjusted for movement of teeth in the user's mouth.

Preferably, the support member defines a transverse loop for conveniently adjusting the tension and position of the bow member.

Preferably, the connector is a sleeve member which receives an end of the bow member into one end, and an anterior end of a support member into the other end.

Alternatively, the connector is a spigot and socket formation.

Preferably, the spigot is secured in a removable manner in the socket formation by chemical, mechanical or thermal means or the like as appropriate.

Preferably, the spigot is secured in a removable manner in the socket formation by bonding, crimping, melting, heat shrinkage or the like as appropriate.

Preferably, the end of at least one selected from the support member and bow member or both will function as a spigot, and the opposed bow member or support member respectively will include a socket formation.

Preferably, the socket formation is secured to an anterior end of a support member or an end of the bow member or both by chemical, mechanical or thermal means or the like as appropriate.

Preferably, the socket formation is secured to an anterior end of a support member or an end of the bow member or both by bonding, crimping, melting, heat shrinkage or the like as appropriate.

Alternatively, the connector is a double socket formation suitable for receiving both the anterior end of a support member and an end of a bow member.

Alternatively, the connector member includes an interrupted sleeve member including a plurality of tabs at each end for receiving anterior end of a support member and an end of a bow member and secured by chemical, mechanical or thermal means or the like as appropriate

Preferably, the socket formation is secured to the anterior end of the support member or an end of the bow member or both by chemical, mechanical or thermal means or the like as appropriate.

Preferably, the socket formation is secured to the anterior end of the support member or an end of the bow member or both by bonding, crimping, melting, heat shrinkage or the like as appropriate.

Preferably, the connector is composed of thermoplastic material.

Preferably, the connector is secured to an end of at least one selected from the support member and the labial bow member by being joined by chemical, mechanical or thermal means or the like as appropriate around the anterior end of said support member and an end labial bow member.

Preferably, the connector is composed of metal.

Preferably, the connector is composed of stainless steel.

Preferably, the connector is secured to an end of at least one selected from the anterior end of the support member and an end of the labial bow member by being joined by chemical, mechanical or thermal means or the like as appropriate.

Preferably, the connector is secured to an end of at least one selected from the anterior end of the support member and an end of the labial bow member by bonding, crimping, melting, heat shrinkage or the like.

Preferably, the connector is composed of stretchable material.

Preferably, the connector is secured to an end of at least one selected from the anterior end of the support member and an end of the labial bow member by being stretched around an end of said support member and labial bow member.

Preferably, the socket formation is secured to either the anterior end of the support member or an end of the bow member or both by being joined by chemical, mechanical or thermal means or the like as appropriate to the end(s).

Alternatively, the socket formation may be integrally formed at either the anterior end of the support member or an end of the bow member.

Preferably, the socket formation is composed of stainless steel.

Alternatively, the connector is a bayonet-type fixing formation.

Alternatively, the connector is a screw in type fixing formation.

Preferably, the dental retainer includes at least one mounting device which is secured to the support member for operationally mounting the bow member and support member to the user's teeth.

Preferably, the mounting device comprises an Adams clasp device suitable for snugly straddling at least one tooth.

Preferably, the mounting device comprises

a base plate which is configured and adapted for operational location on the lingual side of the user's teeth;

a cross over member configured for straddling the embrasure between two teeth; said cross over members being connected between at least one of the support member and the base plate.

Preferably the mounting device comprises a plurality of cross over members corrected between the support members and the base plate.

Preferably the cross over members are composed of wires made from stainless steel, titanium, titanium alloy or any other material commonly employed in orthodontics

Preferably, the mounting device comprises

a base plate which is configured and adapted for operational location on the lingual side of the user's teeth; and

a loop member for looping behind the last tooth of a user and being connected to the base plate.

Preferably, the cross over member and/or the loop member are integrally formed with the base plate.

Preferably, the mounting device includes one or more selected from a base plate, cross over members, loops or Adams clasps, or any combination of these.

Preferably, the mounting device is connected to the support member by means of brazing.

Preferably, the mounting device is connected to the support member by means of soldering.

Preferably, the dental retainer further comprises a canine stabilization component.

Preferably, the canine stabilization component comprises a loop or a tab.

Preferably the canine stabilization component is configured to be in alignment with at least one canine when in operation in a user's mouth, and suitable for providing support to the canine tooth, allowing for force onto any one or more selected from incisors, pre-molars and molars, without affecting the position of the canine.

Preferably, the canine stabilization component is connected to the support member by means of brazing.

Preferably, the canine stabilization component is connected to the support member by means of soldering.

Alternatively, the canine stabilization component is connected to the bow member.

Preferably, the canine stabilization component is integrally formed with the bow member.

Alternatively, the canine stabilization component is moulded onto the bow member.

Preferably the canine stabilization component is composed of a high aesthetic quality material, suitable for disguising the presence of the canine stabilization component in front of a tooth.

Preferably, the canine stabilization component is composed of coated stainless steel wire, titanium wire, titanium alloy wire or wire of any other material commonly employed in orthodontics

Preferably, the canine stabilization component is composed of a polymer or a fiber reinforced polymer composite.

Preferably, the canine stabilization component is composed of thermoplastic material or acrylic.

Preferably, the bow member is a wire with a circular cross-section (although it can be flattened), with diameter ranging from 0.3 mm to 1.5 m,

Preferably, the reinforcing fibers are distributed uniformly in the polymer matrix with a volume fraction ranging from 30% to 80%.

Preferably, the bow member has stiffness values ranging between 500 MPa to 2500 MPa.

In another aspect, the invention may broadly be said to consist of an elongate composite labial bow member, suitable for installation around the labial side of a row of teeth of a user, said bow member including a connector disposed towards at least one end for connecting a support member to the bow member.

Preferably, the bow member comprises a connector at each end for connecting a support member.

Preferably, the connector connects the bow member to the support member in a removable manner.

In another aspect, the invention may broadly be said to consist of a dental retainer suitable for use in retaining a user's teeth in position, said dental retainer comprising

a curved elongate labial bow member suitable for installation around the labial side of a row of teeth of a user, said bow member comprising

reinforcing fibers, and

a polymer matrix;

a pair of elongate support members, suitable for operational disposition alongside a user's teeth in an anterior to posterior alignment, said support members being connected towards their anterior end to opposed ends of the bow member; and

a mounting device for operationally mounting the bow member and support member to the user's teeth.

Preferably, the dental retainer further comprises a canine stabilization component configured to be in alignment with at least one canine when the dental retainer is in operation in a user's mouth, and which allows for the exertion of forces onto teeth anterior to the canine without affecting the position of the canine.

In another aspect, the invention may broadly be said to consist of a kit for assembling a dental retainer, said kit comprising
a curved elongate labial bow member suitable for installation around the labial side of a
row of teeth of a user, said bow member comprising
   reinforcing fibers, and
   a polymer matrix; and
a pair of elongate support members, suitable for operational disposition alongside a user's teeth in an anterior to posterior alignment; and
at least a pair of connectors;
wherein the support members are connectable towards their anterior ends to opposed ends of the bow member by means of the connector.

Preferably, the support members are removably connectable towards their anterior ends to opposed ends of the bow member by means of the connector.

Preferably, the it further comprises a mounting device for operationally mounting the bow member and support member to the user's teeth.

Preferably, the mounting device is connectable to the support member.

Preferably, the mounting device is connectable to the bow member.

Preferably, the kit further comprises a canine stabilization component configured to be in alignment with at least one canine when the dental retainer is in operation in a user's mouth, and which allows for the exertion of forces onto teeth anterior to the canine without affecting the position of the canine.

For the purposes of this specification, the term “polymer” is defined to include all polymeric materials which provide mouldability and resiliency as required by the labial bow member, and specifically include both thermoplastic material and thermoset material

For the purposes of this specification, the term “fiber” is defined to include all forms of fiber yarn(s), braid, roving or any other forms of continuous reinforcement selected from a group consisting of inorganic, natural and synthetic organic materials.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1: shows a dental retainer including a spigot and socket formation as a connector and an Adams Clasp;

FIG. 2: shows a dental retainer including a spigot and socket formation as a connector and a loop for extending behind the back molar of a patient to a base plate;

FIG. 3: shows a dental retainer including a spigot and socket formation as a connector and a cross over member connected to a base plate;

FIG. 4: shows a dental retainer including an interrupted sleeve member as a connector and an Adams Clasp;

FIG. 5: shows a dental retainer including an interrupted sleeve member as a connector and a loop for extending behind the back molar of a patient to a base plate;

FIG. 6: shows a dental retainer including an interrupted sleeve member as a connector and a cross over member connected to a base plate;

FIG. 7: shows a dental retainer including a sleeve member as a connector;

FIG. 8: shows a dental retainer including a sleeve member as a connector and a loop for extending behind the back molar of a patient to a base plate;

FIG. 9: shows a dental retainer including a sleeve member as a connector and a cross over member connected to a base plate;

FIG. 10: shows a dental retainer including a screw in-type fixing formation as a connector and an Adams Clasp;

FIG. 11: shows a dental retainer including a screw in-type fixing formation as a connector and a loop for extending behind the back molar of a patient to a base plate;

FIG. 12: shows a dental retainer including a screw in-type fixing formation as a connector and a cross over member connected to a base plate;

FIG. 13: shows a dental retainer including a bayonet-type fixing formation as a connector and an Adams Clasp;

FIG. 14: shows a dental retainer including a bayonet-type fixing formation as a connector and a loop for extending behind the back molar of a patient to a base plate;

FIG. 15: shows a dental retainer including a bayonet-type fixing formation as a connector and a cross over member connected to a base plate; and

FIG. 16: shows a dental retainer including a loop-shaped canine stabilization formation and an Adam's Clasp;

FIG. 17: shows a dental retainer including a loop-shaped canine stabilization formation and a cross over member connected to a base plate;

FIG. 18: shows a dental retainer including an S-shaped tab-type canine stabilization formation and an Adam's Clasp;

FIG. 19: shows a dental retainer including an S-shaped tab-type canine stabilization formation and a cross over member connected to a base plate; and

FIG. 20: shows a labial bow member and a close up cross section of the bow member showing the reinforcing fibers and the matrix.

### DETAILED DESCRIPTION OF THE PREFERRED EMBODIMENTS

With reference to the above drawings, a dental retainer according to the invention is generally indicated by the numeral 100.

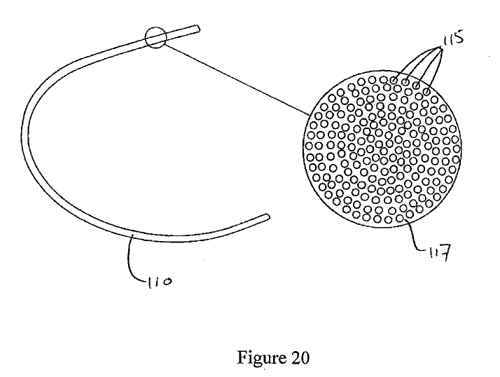

In one embodiment now described there is provided a dental retainer 100, suitable for use in retaining a user's teeth (not shown) in position, said dental retainer 100 comprising a curved labial bow member 110 suitable for abutment against the labial side of a row of teeth of a user, said bow member 110 comprising reinforcing fibers 115 and a polymer matrix 117, as shown in FIG. 20 and as disclosed in PCT publication number WO 2004/111112, which is incorporated herein by reference. The bow member 110 is envisaged as being circular in cross section, although it could also be of a flattened shape in cross section., and is configured and dimensioned to extend operationally from a first end 112a to a second end 112b along the labial side of a user's teeth from at least a pre-molar to a pre-molar on an opposed side of a user's mouth. The bow member 110 is envisaged to be of high aesthetic value in that it does not stand out against a user's teeth. If preferred by the user, however, this need not be the case, and it is envisaged that it can even be colored for visual effect. In a preferred embodiment, the bow member 110 is a wire with a circular cross-section (although it can be flattened), with a diameter ranging from 0.3 mm to 1.5 m. Further, in a preferred embodiment, the reinforcing fibers 115 are distributed uniformly in the polymer matrix with a volume fraction ranging from 30% to 80%.

The stiffness of bow member 110 can be easily varied by engineering the reinforcing fiber 115 design configuration and/or composition without changing the cross sectional dimensions of the bow member 110. This allows for tailoring the stiffness according to the treatment necessities. The bow member 110 possesses excellent resilience and resistance to deformation, without being stiff like traditional stainless steel wires. Thus bow member 110 can significantly reduce the damage to the roots of teeth as observed when using traditional stainless steel labial bows. Preferably, the bow member 110 has stiffness values ranging between 500 MPa to 2500 MPa.

Furthermore, the bow member 110 possesses high tensile strength, allowing repeated adjustment to the bow without any incidence of bow snapping as commonly observed when thermoplastic bows are employed.

The dental retainer 100 further comprises a pair of support members 120 which are connected to the ends 112a & b of the labial bow member 110 at their anterior ends 124a & b respectively. In a preferred embodiment, the support members 120 are connected in a removable manner to the bow member 110.

Preferably, the support members 120 are connected in a removable manner to the labial bow member 110 by means of a connector 130. It is envisaged that the support members 120 will be filamentary in nature, and extend from the ends 112 of the bow member 110 at the support member's anterior end 124, to the posterior of a user's mouth, along the labial side of a user's teeth. In particular, it is envisaged that the support members 120 will be composed of a stainless steel wire. Stainless steel wire is ideal for this purpose. It possesses the required stiffness and resilience and yet is formable to allow for adjustment by an orthodontist according to treatment requirements. In a preferred embodiment, the support member 120 defines a transverse loop 122 for allowing convenient adjustment of the tension and position of the bow member 110. In use or during treatment, the dental retainer 100 can be removed from a user's mouth and the transverse loop 122 may be adjusted by squeezing them with pliers to allow the bow member 110 to adhere more tightly to the teeth, resulting in exertion of heavier forces on the teeth. Alternatively, the transverse loop 122 can be pried apart, so as to reduce the forces exerted on the teeth. This helps maintain the teeth in their corrected state.

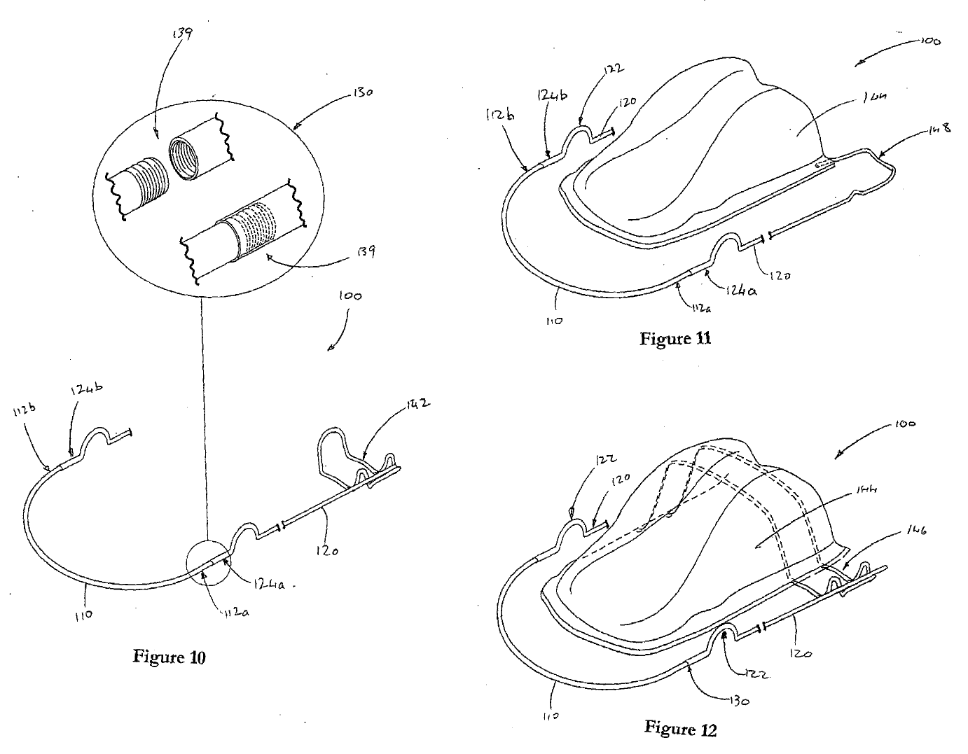

The connector 130 can take several embodiments. In a first embodiment, the connector can be a sleeve member 132 (as shown in FIGS. 7, 8 and 9) which receives an end 112 of the bow member 110 into one sleeve end, and the anterior end 124 of the support member 120 into the other sleeve end. It is envisaged that the connector 130 can be composed of thermoplastic material, and that it is secured to the ends 124 and 112 by chemical, mechanical or thermal means or the like as appropriate. Such processes may be heat shrinking, crimping, resin or glue bonding or the like. Alternatively, the connector 130 can be composed of stainless steel, and the sleeve can be joined by similar chemical, mechanical or thermal means or the like as appropriate to the ends 112 of the bow member 110 and anterior ends 124 of the support member 120. In another alternative embodiment, the connector 130 can be composed of stretchable material, and the sleeve can be stretched around the ends 112 of the bow member 110 and anterior ends 124 of the support member 120, thereby securing them together in a removable manner.

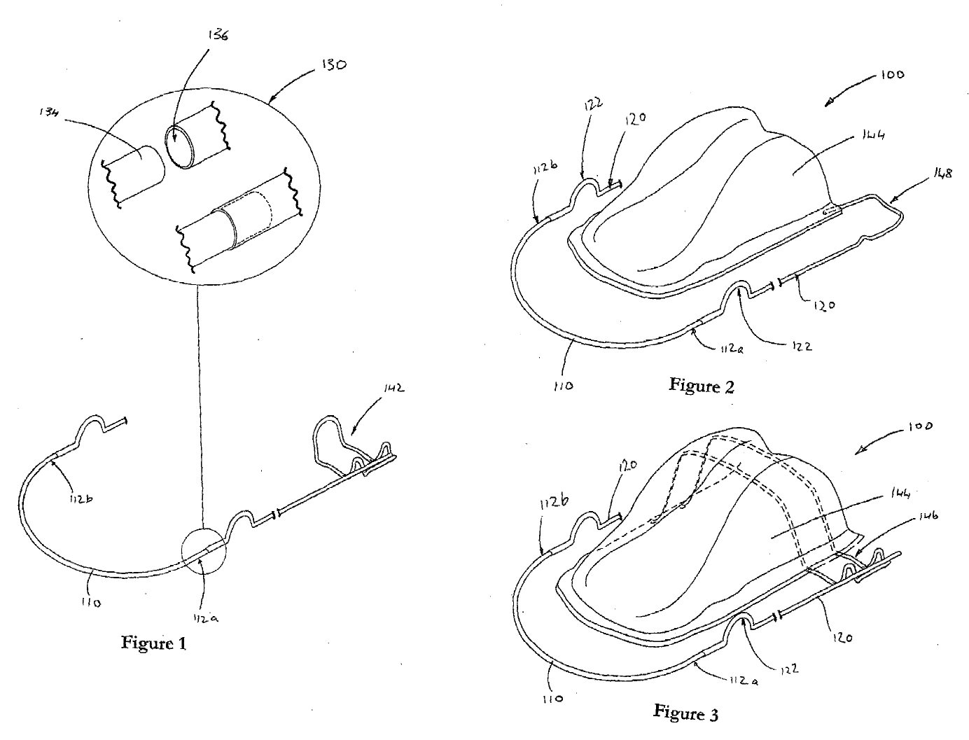

In another embodiment (as shown in FIGS. 1, 2 and 3), the connector 130 is a spigot 134 and socket formation 136, wherein the spigot 134 is disposed on one of either the anterior end 124 of the support member 120 or an end 112 of the bow member 110, and the socket formation 136 is disposed on the other of the anterior end 124 of the support member 120 or an end 112 of the bow member 110. The socket formation 136 may be integrally formed as part of the ends 112, 124, or can be a separate member having a double socket formation 136 which is secured to the ends 112, 124, by chemical, mechanical, thermal means or the like as appropriate. In this embodiment, it is envisaged that the ends 112 of the bow member 110 and the anterior ends 124 of the support member 120 will act as a spigot 134. The socket formation 136 can be composed of stainless steel, thermoplastic, or any suitable polymer or composite material.

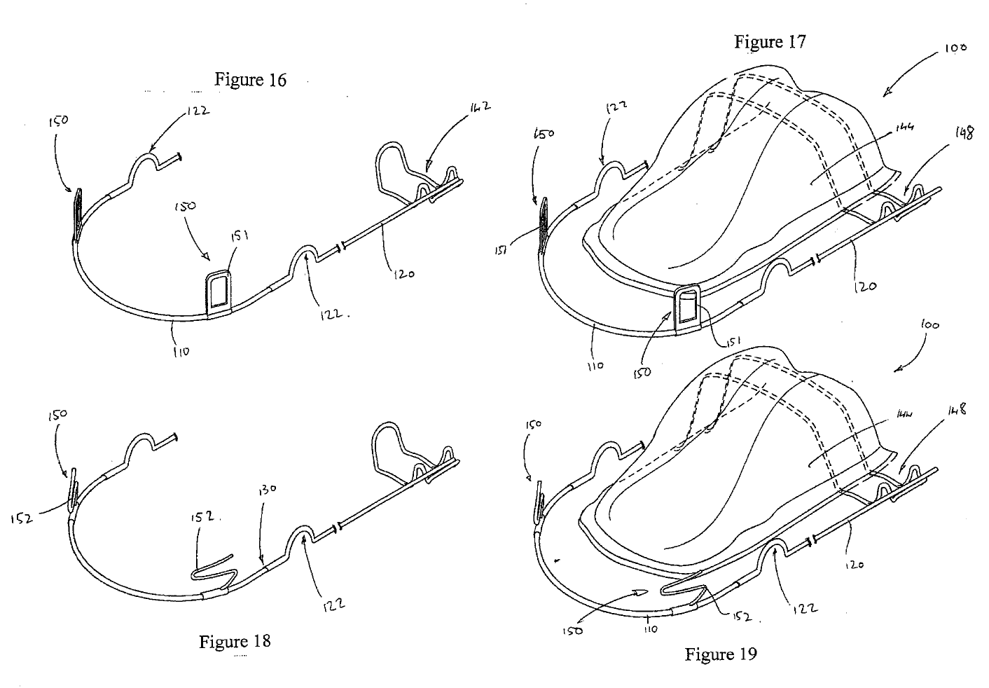

In another embodiment, the connector 130 is a bayonet-type fixing formation 138 (shown in FIGS. 13, 14 and 15), and can be in the form of a separate member for securing with the ends 112, of the bow member 110 or the anterior ends 124 of the support member 120, or integrally formed as part of the ends 112 of the bow member 110 or anterior ends 124 of the support member 120.

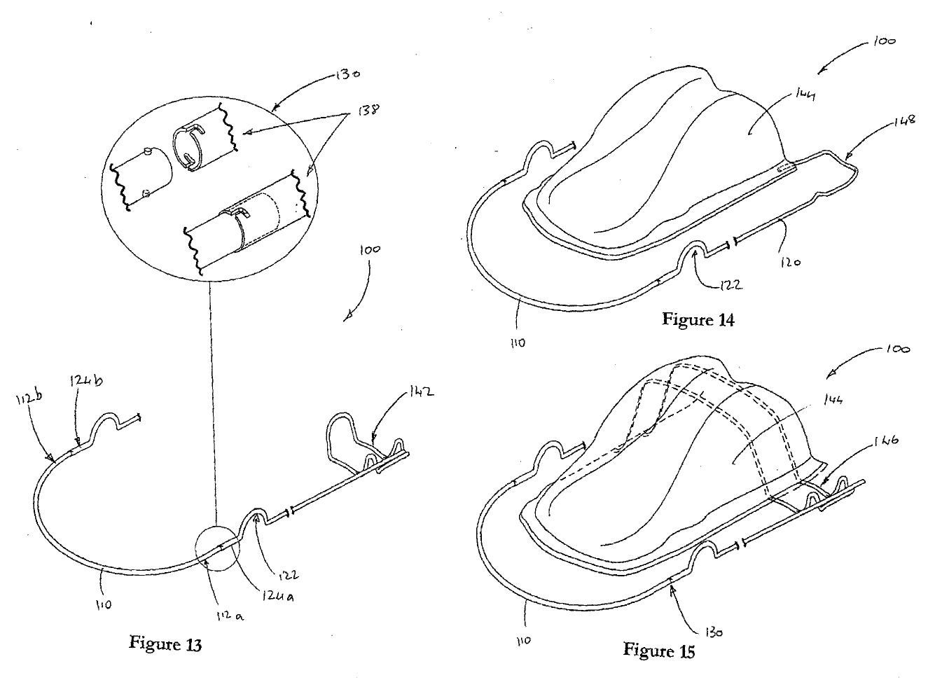

In a further embodiment, the connector 130 can be a screw in-type fixing formation 139 and can be in the form of a separate screw member for securing with the ends 112 of the bow member 110 or anterior ends 124 of the support member 120, or integrally formed as part of the ends 112 of the bow member 110 or anterior ends 124 of the support member 120 (as shown in FIGS. 10, 11 and 12).

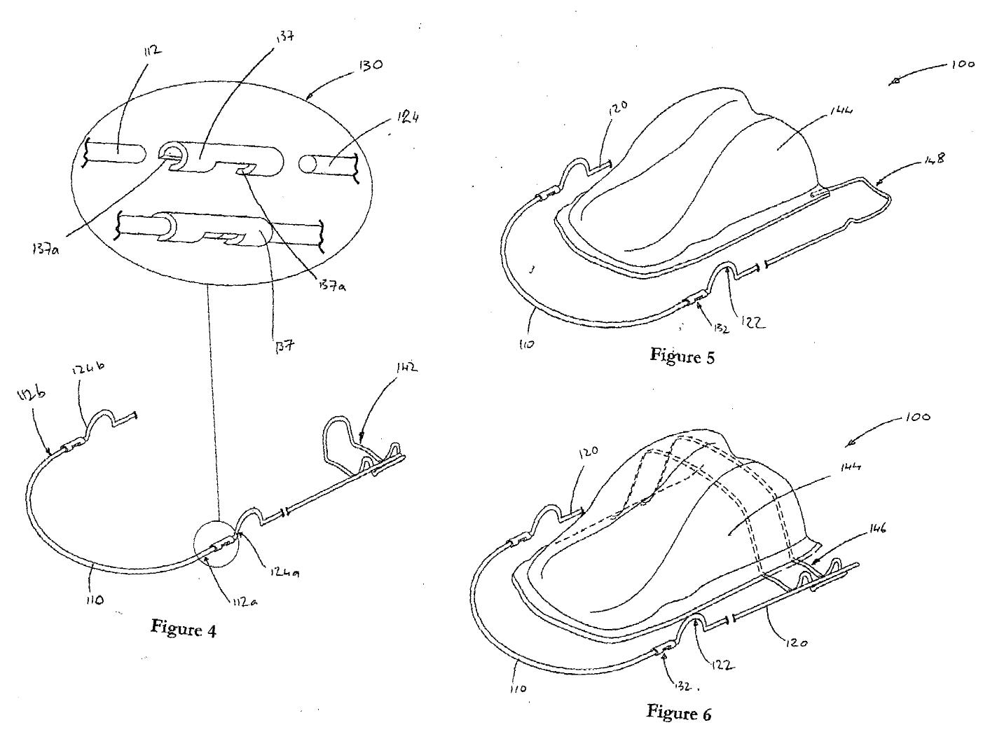

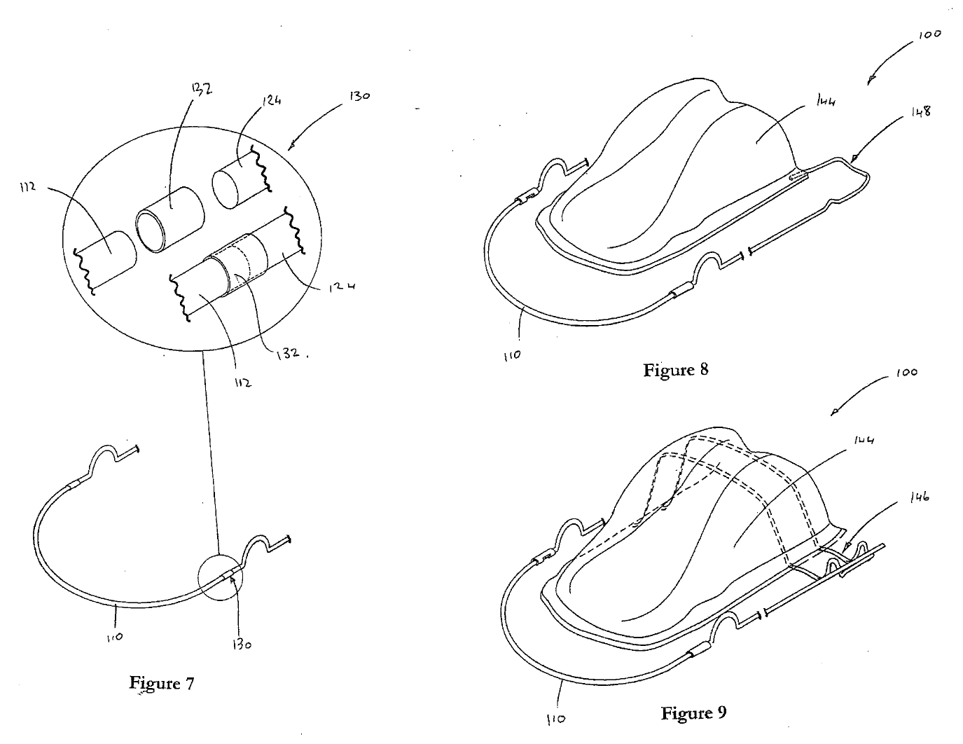

In another embodiment, the connector member 130 is an interrupted sleeve member 137 (as shown in FIGS. 4, 5, and 6) including a plurality of tabs 137a at each end for receiving an anterior end 124 of a support member 120 and an end 112 of a bow member 110 and secured by chemical, mechanical or thermal means or the like as appropriate. The bow member 110 and the support member 120 are mounted onto a mounting device to create a dental retainer. The mounting device can be one of a number of embodiments. In a first embodiment, the mounting device comprises an “Adams clasp” device 142 (as shown in FIGS. 1, 4, 10 and 13) suitable for snugly straddling at least one tooth, preferably a molar, to mount the bow member 110 and the support member 120 to the user's teeth. An Adams Clasp usually comprises at least one loop of filamentary material such as stainless steel which is brazed or soldered to the support member 120 and extends through an embrasure between two teeth, then across a tooth and back through an adjacent embrasure.

In another embodiment, the mounting device comprises a base plate 144 which is configured and adapted for operational location on the lingual side of the user's teeth, on the roof and/or floor of the oral cavity (not shown); and a plurality of cross over members 146 (as shown in FIGS. 3, 6, 9, 12 and 15) connected between at least one of the support member 120 and the base plate 144, and configured for straddling an embrasure between two teeth. Cross over members 146 are usually composed of stainless steel wire and are brazed or soldered to the support member 120. Preferably, cross over members 146 will be brazed with cadmium free silver solder, such as 45/30/25 alloy as per Federal standard QQ-B-654.

In yet another embodiment, the mounting device comprises a base plate 144; and a loop member 148 (as shown in FIGS. 2, 5, 8, 11 and 14) which, when in operation in a user's mouth, loops behind the last molar of the user and is connected to the base plate 144. The loop member 148 can be an extension of the support member 120, or can be composed of stainless steel wire and brazed or soldered to the posterior end of the support member 120.

It is envisaged that the cross over members 146 and/or the loop member 148 will be integrally moulded into the base plate 144 for sturdiness. It is further envisaged that any number of base plates 144, cross over members 146, loop members 148 or Adams clasp 142, may be used in combination with any number of the others.

The dental retainer 100 can further comprise a canine stabilization component 150 (as shown in FIGS. 16-19). A canine stabilization component 150 usually comprises a loop 151 (as shown in FIGS. 16 and 17) or a tab 152 (as shown in FIGS. 18 and 19) which is configured to be in alignment with one of the user's canines (not shown) when the dental retainer 100 is mounted in a user's mouth. It is envisaged that the canine stabilization component 150 could be of any shape other than the loop 151 or S-shaped tab 152 as shown. The canine stabilization component 150 provides support to the canine, allowing for force to be applied onto teeth anterior to the canine without affecting the position of the canine. The canine stabilization component 150 can be connected to the support member 120 by means of brazing or soldering. In a preferred embodiment, the canine stabilization component 150 is composed of a high aesthetic quality material, suitable for disguising the presence of the canine stabilization component 150 in front of the canine, such as a polymer or a fiber reinforced polymer composite, preferably of acrylic or thermoplastic material, although this is not critical. It could also be composed of coated stainless steel wire, titanium wire, titanium alloy wire or wire of any other material commonly employed in orthodontics.

It is also envisaged that the canine stabilization component 150 could be connected to the bow member 110 rather than the support member 120, either by being moulded onto the bow member 110, or by being integrally formed with the bow member 110.

The combined effect of the features of the dental retainer are that an aesthetically pleasing retainer may be fashioned (as the bow member 110 is composed of material that is aesthetically pleasing), but which may be easily adjusted by the orthodontist during the various phases of treatment. Additionally, where the bow member 110 is connected in a removable manner to the support member 120 it enables individual replacement of the bow member 110 or support member 120 if they are damaged or become unsuitable for/during that particular phase of treatment of the patient.

It is envisaged that individual bow members 110 could be sold, each including a pair of connectors 130 disposed towards each end 112a & 112b, for connecting a support member 120 to the bow member 110. The choice of support members 120 to be secured to the bow member 110 would then be available to the orthodontist. The orthodontist could further decide whether to removably or permanently connect the support member 120 to the bow member 110.

It is still further envisaged that any combination of the bow member 110, support members 120 and connectors 130, as well as the mounting devices 140 and the canine stabilization component 150, can be sold in a kit form, for convenient assembly by the orthodontist.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

We claim:

1) A dental retainer, suitable for use in retaining a user's teeth in position, said dental retainer comprising
a curved elongate labial bow member suitable for installation around the labial side of a row of teeth of a user, said bow member comprising
reinforcing fibers, and
a polymer matrix; and
at least one elongate support member, suitable for operational disposition alongside a user's teeth in an anterior to posterior alignment, said support member being connected towards its anterior end to an end of the bow member.

2) A dental retainer as claimed in claim 1, comprising a pair of support members, each connected to an end of the bow member.

3) A dental retainer as claimed in claim 2, wherein the support members are removably connected to the bow member.

4) A dental retainer as claimed in claim 2, wherein the bow member is configured to extend operationally from at least the labial side of a pre-molar to the labial side of a pre-molar on an opposed side of a user's mouth.

5) A dental retainer as claimed in claim 2, wherein the support member is connected to the labial bow member by means of a connector.

6) A dental retainer as claimed in claim 5, wherein the connector removably connects the bow member to the support member.

7) A dental retainer as claimed in claim 2, wherein the support member is filamentary in nature.

8) A dental retainer as claimed in claim 2, wherein the support member is substantially circular in cross section.

9) A dental retainer as claimed in claim 2, wherein the support member is formable, to enable the support member to be adjusted for movement of teeth in the user's mouth.

10) A dental retainer as claimed in claim 2, wherein the support member is composed of a stiff and resilient material selected from one or more of stainless steel, titanium, titanium alloys, and any other suitable material.

11) A dental retainer as claimed in claim 2, wherein the support member defines a transverse loop for conveniently adjusting the tension and position of the bow member.

12) A dental retainer as claimed in claim 5, wherein the connector is a sleeve member which receives an end of the bow member into one end, and an anterior end of a support member into the other end.

13) A dental retainer as claimed in claim 5, wherein the connector is a spigot and socket formation.

14) A dental retainer as claimed in claim 13, wherein the spigot is removably securable in the socket formation.

15) A dental retainer as claimed in claim 13, wherein the end of at least one selected from the support member and bow member or both is a spigot, and the other of the bow member or support member respectively has a socket formation.

16) A dental retainer as claimed in claim 13, wherein the socket formation is secured to an end of either the support member or the bow member.

17) A dental retainer as claimed in claim 5, wherein the connector is a double socket formation suitable for receiving both an end of a support member and an end of a bow member.

18) A dental retainer as claimed in claim 5, wherein the connector is secured to an end of either the support member or the bow member or both by means of one or more selected from chemical,. mechanical, and thermal means.

19) A dental retainer as claimed in claim 5, wherein the connector is secured to an end of either the support member or the bow member or both by bonding.

20) A dental retainer as claimed in claim 5, wherein the connector is composed of thermoplastic material.

21) A dental retainer as claimed in claim 5, wherein the connector is secured to an end of at least one selected from the support member and the labial bow member by being heat shrunk around the end of said support member and labial bow member.

22) A dental retainer as claimed in claim 5, wherein the connector is composed of metal.

23) A dental retainer as claimed in claim 5, wherein the connector is composed of one or more materials selected from stainless steel, titanium, titanium alloy, or any other suitable material.

24) A dental retainer as claimed in claim 5, wherein the connector is secured to an end of at least one selected from the support member and the labial bow member by being crimped onto the end(s).

25) A dental retainer as claimed in claim 5, wherein the connector is composed of stretchable material.

26) A dental retainer as claimed in claim 5, wherein the connector is secured to an end of at least one selected from the support member and the labial bow member by being stretched around an end of said support nrieniber and labial bow member.

27) A dental retainer as claimed in claim 5, wherein the connector is integrally formed at an end of either the support member or the bow member.

28) A dental retainer as claimed in claim 5, wherein the connector includes a bayonet-type fixing formation.

29) A dental retainer as claimed in claim 5, wherein the connector includes a screw in-type fixing formation.

30) A dental retainer as claimed in claim 5, wherein the connector includes a snap-fit type formation.

31) A dental retainer as claimed in claim 5, wherein the connector includes an interrupted sleeve member including a plurality of tabs at each end for crimping to an end of a support member and an end of a bow member.

32) A dental retainer as claimed in claim 1, wherein the dental retainer includes at least one mounting device which is secured to the support member for operationally mounting the bow member and support member to the user's teeth.

33) A dental retainer as claimed in claim 32, wherein the mounting device comprises an Adams clasp device suitable for snugly straddling at least one tooth.

34) A dental retainer as claimed in claim 32, wherein the mounting device comprises
a base plate which is configured and adapted for operational location on the lingual side of the user's teeth;
a cross over member configured for straddling the embrasure between two teeth; said cross over member being connected between the support member and the base plate.

35) A dental retainer as claimed in claim 32, wherein the mounting device comprises a plurality of cross over members connected between the support members and the base plate.

36) A dental retainer as claimed in claim 34, wherein the cross over member is a wire composed of one or more materials selected from stainless steel, titanium, titanium alloy, and any other suitable material.

37) A dental retainer as claimed in claim 34, wherein the cross over member is integrally moulded with the base plate.

38) A dental retainer as claimed in claim 32, wherein the mounting device comprises
a base plate which is configured and adapted for operational location on the lingual side of the user's teeth; and
a loop member for looping behind the last tooth of a user and being connected to the base pate.

39) A dental retainer as claimed in claim 38, wherein the loop member is integrally moulded with the base plate.

40) A dental retainer as claimed in claim 32, wherein the mounting device includes one or more selected from a base plate, cross over members, loop members or Adams clasps, or any combination of these.

41) A dental retainer as claimed in claim 32, wherein the mounting device is connected to the support member by means of brazing.

42) A dental retainer as claimed in claim 32, wherein the mounting device is connected to the support member by means of soldering.

43) A dental retainer as claimed in claim 1, wherein the dental retainer further comprises a canine stabilization component.

44) A dental retainer as claimed in claim 43, wherein the canine stabilization component is selected from one of a loop and a tab.

45) A dental retainer as claimed in claim 43, wherein the canine stabilization component is configured to be in alignment with at least one canine when in operation in a user's mouth, and suitable for providing support to the canine tooth, allowing for force onto any one or more selected from incisors, pre-molars and molars, without affecting the position of the canine.

46) A dental retainer as claimed in claim 43, wherein the canine stabilization component is connected to the support member by means of brazing.

47) A dental retainer as claimed in claim 43, wherein the canine stabilization component is connected to the support member by means of soldering.

48) A dental retainer as claimed in claim 43, wherein the canine stabilization component is connected to the bow member.

49) A dental retainer as claimed in claim 48, wherein the canine stabilization component is integrally formed with the bow member.

50) A dental retainer as claimed in claim 48, wherein the canine stabilization component is moulded onto the bow member.

51) A dental retainer as claimed in claim 43, wherein the canine stabilization component is composed of a high aesthetic quality material, suitable for disguising the presence of the canine stabilization component in front of a tooth.

52) A dental retainer as claimed in claim 43, wherein the canine stabilization component is composed of a material selected from one or more of stainless steel, titanium, titanium alloys, and any other suitable material.

53) A dental retainer as claimed in claim 43, wherein the canine stabilization component is composed of thermoplastic material.

54) A dental retainer as claimed in claim 43, wherein the canine stabilization component is composed of acrylic.

55) A dental retainer as claimed in claim 1, which is conveniently removable from a user's mouth.

56) A dental retainer as claimed in claim 1, wherein the reinforcing fibers are ceramic fibers such as glass fibers.

57) A dental retainer as claimed in claim 1, wherein the reinforcing fibers are composed of a material selected from one or more of ceramic fibers such as glass fibers, and polymeric fibers such as polyethylene, polypropylene, Ultra High Molecular Weight Polyethylene (HHMWPE), Nylon, or the like.

58) A dental retainer as claimed in claim 1, wherein the polymer matrix is of a high quality aesthetic nature as appropriate for orthodontic applications.

59) A dental retainer as claimed in claim 1, wherein the labial bow member is a wire with a circular cross-section having a diameter ranging from 0.3 mm to 1.5 mm,

60) A dental retainer as claimed in claim 1, wherein the reinforcing fibers are distributed uniformly in the polymer matrix with a volume fraction ranging from 30% to 80%.

61) A dental retainer as claimed in claim 1, wherein the labial bow member has a stiffness value ranging between 500 MPa to 2500 MPa.

62) An elongate composite labial bow member, suitable for installation around the labial side of a row of teeth of a user, said bow member including a connector disposed towards at least one end for connecting a support member to the bow member.

63) A labial bow member as claimed in claim 62, comprising a connector at each end for connecting a support member.

64) A labial bow member as claimed in claim 62, wherein the support member is connectable to the bow member in a removable manner.

65) A dental retainer suitable for use in retaining a user's teeth in position, said dental retainer comprising
a curved elongate labial bow member suitable for installation around the labial side of a row of teeth of a user, said bow member comprising
reinforcing fibers, and
a polymer matrix;
a pair of elongate support members, suitable for operational disposition alongside a user's teeth in an anterior to posterior alignment, said support members being connected towards their anterior end to opposed ends of the bow member; and
a mounting device for operationally mounting the bow member and support member to the user's teeth.

66) A dental retainer as claimed in claim 65, further comprising a canine stabilization component configured to be in alignment with at least one canine when the dental retainer is in operation in a user's mouth, and which allows for the exertion of forces onto teeth anterior to the canine without affecting the position of the canine.

67) A kit for assembling a dental retainer, said kit comprising
a curved elongate labial bow member suitable for installation around the labial side of a row of teeth of a user, said bow member comprising
reinforcing fibers, and
a polymer matrix; and
a pair of elongate support members, suitable for operational disposition alongside a user's teeth in an anterior to posterior alignment; and
at least a pair of connectors;
wherein the support members are connectable towards their anterior ends to opposed ends of the bow member by means of the connector.

68) A kit as claimed in claim 67, wherein the support members are removably connectable towards their anterior ends to opposed ends of the bow member by means of the connector.

69) A kit as claimed in claim 67, further comprising a mounting device for operationally mounting the bow member and support member to the user's teeth.

70) A kit as claimed in claim 67, wherein the mounting device is connectable to the support member.

71) A kit as claimed in claim 67, wherein the mounting device is connectable to the bow member.

72) A kit as claimed in claim 67, further comprising a canine stabilization component configured to be in alignment with at least one canine when the dental retainer is in operation in a user's mouth, and which allows for the exertion of forces onto teeth anterior to the canine without affecting the position of the canine.
